(19) United States
(12) Patent Application Publication
(10) Pub. No.: US 2025/0297570 A1
(43) Pub. Date: Sep. 25, 2025

(54) RENEWABLE ENERGY UTILIZATION SYSTEM BASED ON NITROGEN-FREE COMBUSTION AND CARBON DIOXIDE RECYCLING

(71) Applicant: TIANJIN UNIVERSITY, Tianjin (CN)

(72) Inventors: Mingfa YAO, Tianjin (CN); Bowen LI, Tianjin (CN); Zongyu YUE, Tianjin (CN); Haifeng LIU, Tianjin (CN)

(21) Appl. No.: 18/863,559

(22) PCT Filed: Dec. 7, 2022
(86) PCT No.: PCT/CN2022/137180

§ 371 Date: Nov. 6, 2024

(51) Int. Cl. F02B 43/10; B01D 53/14; B01D 53/26; B01J 19/00; B01J 19/24; C01B 3/32; C25B 9/19; C25B 15/08

(52) U.S. Cl. CPC F02B 43/10; B01D 53/26; B01J 19/0013; B01J 19/245; C01B 3/323; C25B 9/19; C25B 15/081; C25B 15/085; B01D 53/14; B01D 2256/22; B01D 2257/80; B01J 2219/00103; C01B 2203/0205; C01B 2203/1223; C01B 2203/84

(57) ABSTRACT

The present disclosure provides a renewable energy utilization system based on nitrogen-free combustion and carbon dioxide recycling. The system includes: an electrolysis unit used to electrolyze water using renewable energy to obtain hydrogen and oxygen; a carbon dioxide collection unit used to collect carbon dioxide gas released during utilization of the renewable energy; a methanol synthesis unit used to synthesize methanol using the hydrogen and the carbon dioxide gas; an internal combustion engine generator set used to perform nitrogen-free combustion of the methanol and the oxygen to generate exhaust gas and electrical energy; and a methanol reforming reaction unit used to catalyze a reforming reaction of the methanol using residual heat of the exhaust gas to obtain synthesis gas, and input the synthesis gas into the internal combustion engine generator set as a fuel for the internal combustion engine generator set.

### CROSS REFERENCE TO RELATED APPLICATION(S)

This application is a National Stage Application of International Application No. PCT/CN2022/137180, filed on Dec. 7, 2022, entitled “RENEWABLE ENERGY UTILIZATION SYSTEM BASED ON NITROGEN-FREE COMBUSTION AND CARBON DIOXIDE RECYCLING”, the entire content of which is incorporated herein in its entirety by reference.

### TECHNICAL FIELD

The present disclosure relates to a field of renewable energy technology, and in particular to a renewable energy utilization system based on nitrogen-free combustion and carbon dioxide recycling.

### BACKGROUND

In recent years, the installation and power generation of renewable energy represented by wind power and solar photovoltaic power has developed rapidly. However, since wind power and solar photovoltaic power have certain randomness and intermittency and lack control performance to support the safe and stable operation of the power system, the safety of the power grid is effected greatly. When the wind power and the solar photovoltaic power are greater than 20%, the power grid will be unsafe. Therefore, integrating the wind power and the solar photovoltaic power into the power grid must require to adjust the power supply, and accommodating more renewable energy requires more peak-shaving power supply and more frequency modulated power supply. Otherwise, it will lead to large-scale “abandoned wind and solar photovoltaic”, resulting in economic losses and energy waste. Therefore, how to convert random and intermittent wind energy and solar energy into a stable energy supply is a technical problem that needs to be solved urgently.

### SUMMARY

In view of this, the present disclosure provides a renewable energy utilization system based on nitrogen-free combustion and carbon dioxide recycling, including an electrolysis unit, a carbon dioxide collection unit, a methanol synthesis unit, an internal combustion engine generator set, and a methanol reforming reaction unit.

The electrolysis unit is configured to electrolyze water using renewable energy to obtain hydrogen and oxygen.

The carbon dioxide collection unit is configured to collect carbon dioxide gas released during a utilization process of the renewable energy.

The methanol synthesis unit is connected to the electrolysis unit and the carbon dioxide collection unit. The methanol synthesis unit is configured to synthesize methanol using the hydrogen and the carbon dioxide gas.

The internal combustion engine generator set is connected to the methanol synthesis unit, the electrolysis unit and the carbon dioxide collection unit. The internal combustion engine generator set is configured to combust the methanol with the oxygen, provide electrical energy to a first load terminal, and discharge exhaust gas.

The methanol reforming reaction unit is connected to the internal combustion engine generator set and the methanol synthesis unit. The methanol reforming reaction unit is configured to catalyze a reforming reaction of the methanol using residual heat of the exhaust gas to obtain synthesis gas, and input the synthesis gas into the internal combustion engine generator set as a fuel for the internal combustion engine generator set.

According to the embodiments of the present disclosure, the methanol synthesis unit includes a methanol synthesis tower and a methanol separator.

The methanol synthesis tower is configured to react the hydrogen with the carbon dioxide gas to obtain methanol mixed gas.

The methanol separator is connected to the methanol synthesis tower. The methanol separator is configured to separate the methanol mixed gas to obtain the methanol.

According to the embodiments of the present disclosure, the electrolysis unit includes an electrolysis device, a driving device, a hydrogen separator, and an oxygen separator.

The electrolysis device is connected to a power supply system. The electrolysis device is configured to electrolyze the water to obtain hydrogen mixed gas and oxygen mixed gas.

The driving device is connected to the electrolysis device and a water storage tank. The driving device is configured to transport the water to the electrolysis device.

The hydrogen separator is connected to the electrolysis device. The hydrogen separator is configured to dehumidify the hydrogen mixed gas to obtain the hydrogen.

The oxygen separator is connected to the electrolysis device. The oxygen separator is configured to dehumidify the oxygen mixed gas to obtain the oxygen.

According to the embodiments of the present disclosure, the electrolysis device includes a proton exchange membrane.

According to the embodiments of the disclosure, the internal combustion engine generator set includes an internal combustion engine cylinder, a methanol transport device, an intake pipe and an exhaust pipe.

The internal combustion engine cylinder is configured to perform combustion of the methanol and the oxygen.

A first end of the methanol transport device is connected to the methanol synthesis unit, a second end of the methanol transport device is connected to the internal combustion engine cylinder, and the methanol transport device is configured to transport the methanol to the internal combustion engine cylinder.

A first end of the intake pipe is connected to the electrolysis unit, a second end of the intake pipe is connected to the internal combustion engine cylinder, the intake pipe is configured to transport the oxygen to the internal combustion engine cylinder, a third end of the intake pipe is connected to the methanol reforming reaction unit, and the intake pipe is further configured to transport the synthesis gas to the internal combustion engine cylinder.

A first end of the exhaust pipe is connected to the internal combustion engine cylinder, a second end of the exhaust pipe is connected to the methanol reforming reaction unit, and the exhaust pipe is configured to transport the exhaust gas to the methanol reforming reaction unit.

According to the embodiments of the present disclosure, the carbon dioxide collection unit includes a carbon dioxide separator, a carbon dioxide capture device, and a carbon dioxide storage tank.

A first end of the carbon dioxide separator is connected to the internal combustion engine generator set, and the carbon dioxide separator is configured to separate the carbon dioxide gas in the exhaust gas.

The carbon dioxide capture device is connected to a carbon dioxide storage tank. The carbon dioxide capture device is configured to collect the carbon dioxide gas released in air during the utilization process of the renewable energy.

The carbon dioxide storage tank is connected to the carbon dioxide separator and the carbon dioxide capture device. The carbon dioxide storage tank is configured to store the carbon dioxide gas in the exhaust gas and the carbon dioxide gas in the air.

According to the embodiments of the present disclosure, a first valve is provided between the carbon dioxide storage tank and the carbon dioxide separator.

According to the embodiments of the present disclosure, the above system further includes a residual heat recovery unit. The residual heat recovery unit is connected to the internal combustion engine generator set. The residual heat recovery unit is configured to recover the residual heat of the exhaust gas to provide energy to a second load terminal.

According to the embodiments of the present disclosure, the residual heat recovery unit is further connected to the carbon dioxide collection unit, and the residual heat recovery unit is further configured to collect the carbon dioxide gas in the exhaust gas after the residual heat of the exhaust gas is recovered. The residual heat recovery unit is further connected to the methanol synthesis unit and the electrolysis unit, and the residual heat recovery unit is further configured to perform combustion using the methanol and the oxygen in a case that the residual heat does not meet an energy requirement of the load terminal, so as to meet the energy requirement of the load terminal.

According to the embodiments of the present disclosure, the above system further includes a water vapor collection unit. The water vapor collection unit is connected to the methanol synthesis unit, the carbon dioxide collection unit and the residual heat recovery unit. The water vapor collection unit is configured to collect water vapor generated during a utilization process of the renewable energy.

### BRIEF DESCRIPTION OF THE DRAWINGS

FIG. 1 schematically shows an exemplary architecture diagram of a renewable energy recycling utilization system according to some embodiments of the present disclosure;

FIG. 2 schematically shows an exemplary architecture diagram of a renewable energy recycling utilization system according to some other embodiments of the present disclosure:

FIG. 3 schematically shows an exemplary architecture diagram of a residual heat recovery unit according to the embodiments of the present disclosure.

### DETAILED DESCRIPTION OF EMBODIMENTS

In order to make the purpose, technical solution, and advantages of the present disclosure clearer, the present disclosure is further explained in detail below in conjunction with specific embodiments and accompanying drawings.

Wind energy and solar energy vary greatly with climate and seasonality. Energy storage technology is considered to be a key technology for the large-scale utilization of wind energy and solar energy in the future. Common energy storage technologies include water energy storage, air energy storage, electrochemical energy storage, hydrogen and hydrogen-based fuel energy storage, and thermal energy storage. However, each energy storage technology has its inherent advantages and disadvantages as well as application scenarios. For example, water energy storage has low energy density, electrochemical energy storage may only meet short-term requirements, and hydrogen has disadvantages of being difficult to store for long periods of time and high storage costs.

In view of this, the embodiments of the present disclosure provide a renewable energy recycling utilization system, of which the main concepts are as follows.

Hydrogen is produced by using unstable wind power and solar power generation, and methanol is produced by using hydrogen and carbon dioxide, so as to achieve the methanol fuel chemical energy storage. An internal combustion engine generator set provides electrical energy by combusting methanol. The exhaust gas from the internal combustion engine generator set may provide heat energy. The combustion products of the internal combustion engine, i.e. water and carbon dioxide, may be recycled to produce hydrogen and methanol, achieving a closed cycle of carbon dioxide and water.

Nitrogen-free combustion is performed in the internal combustion engine generator set, that is, oxygen generated by electrolyzing water for hydrogen is introduced into the internal combustion engine generator set, so as to increase the concentration of carbon dioxide in the combustion products, thereby reducing energy consumption of carbon recovery and eliminating nitrogen oxide in combustion. At the same time, in order to suppress the excessive combustion temperature generated by pure oxygen combustion, some carbon dioxide is mixed into the intake air, so that the combustion products are only water and carbon dioxide, which are easy to be recycled and reused.

During the intake process, some methanol is decomposed into synthesis gas by using the residual heat of the exhaust gas from the internal combustion engine generator set. That is, the internal combustion engine generator set uses the methanol fuel and the synthesis gas generated by methanol reforming for combustion. The residual heat of the exhaust gas will further achieve the cascade utilization of the residual heat from the internal combustion engine generator set through a residual heat supplemental combustion type cooling and heating set.

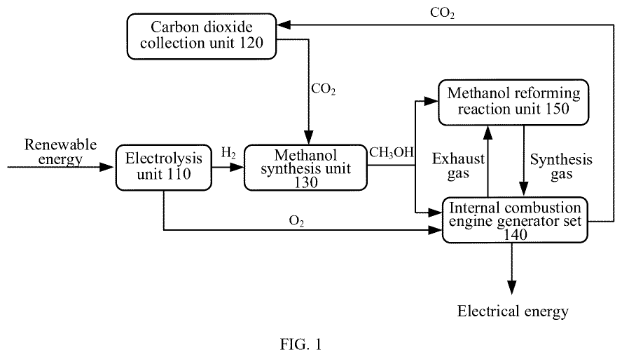

FIG. 1 schematically shows an exemplary architecture diagram of a renewable energy recycling utilization system according to some embodiments of the present disclosure.

As shown in FIG. 1, a renewable energy utilization system 100 based on nitrogen-free combustion and carbon dioxide recycling includes an electrolysis unit 110, a carbon dioxide collection unit 120, a methanol synthesis unit 130, an internal combustion engine generator set 140, and a methanol reforming reaction unit 150.

According to the embodiments of the present disclosure, the methanol synthesis unit 130 is connected to the electrolysis unit 110 and the carbon dioxide collection unit 120. The internal combustion engine generator set 140 is connected to the methanol synthesis unit 130, the electrolysis unit 110, and the carbon dioxide collection unit 120. The methanol reforming reaction unit 150 is connected to the internal combustion engine generator set 140 and the methanol synthesis unit 130.

According to the embodiments of the present disclosure, unstable renewable energy may be used by the electrolysis unit 110 to electrolyze water, so as to obtain hydrogen and oxygen. Since carbon dioxide gas may be released during the utilization of renewable energy, the released carbon dioxide may be collected by the carbon dioxide collection unit 120.

According to the embodiments of the present disclosure, the methanol synthesis unit 130 is used to synthesize methanol using the hydrogen generated by the electrolysis unit 110 and the carbon dioxide gas collected by the carbon dioxide collection unit 120 for chemical energy storage. Methanol may be combusted in the internal combustion engine generator set 140, while the oxygen generated by the electrolysis unit 110 is introduced into the internal combustion engine generator set 140, so as to achieve nitrogen-free combustion of methanol in the internal combustion engine generator set 140, so that the generated exhaust gas does not contain nitrogen oxide.

According to the embodiments of the present disclosure, the exhaust gas generated by the combustion of methanol in the internal combustion engine generator set 140 may be input into the methanol reforming reaction unit 150. At the same time, the methanol reforming reaction unit 150 is connected to the methanol synthesis unit 130, so as to use the residual heat of the exhaust gas to catalyze the reforming reaction of methanol to obtain synthesis gas. The synthesis gas may include carbon monoxide and hydrogen. The synthesis gas is input into the internal combustion engine generator set 140 as a fuel for the internal combustion engine generator set, and then nitrogen-free combustion of the synthesis gas, methanol and oxygen is performed to generate electrical energy for a first load terminal. The first load terminal may be a first load terminal 150.

According to the embodiments of the present disclosure, unstable renewable energy is used to electrolyze water in the electrolysis unit to obtain hydrogen and oxygen, the carbon dioxide gas released in the renewable energy utilization system is recovered through the carbon dioxide collection unit, and the hydrogen and the carbon dioxide gas are converted into methanol using the methanol synthesis unit for chemical energy storage. The cross-season energy storage is achieved using methanol fuel, and the methanol fuel may be transported to other energy systems for utilization, achieving flexible energy storage configuration. The methanol is combusted using the internal combustion engine generator set, and the generated exhaust gas enters the methanol reforming reaction unit, achieving integrated utilization of the exhaust gas. The carbon dioxide generated by combustion is then collected by the carbon dioxide collection unit and is input into the methanol synthesis unit, achieving recycling of carbon dioxide and achieving the technical effect of system zero carbon discharge and high-efficient utilization of renewable energy.

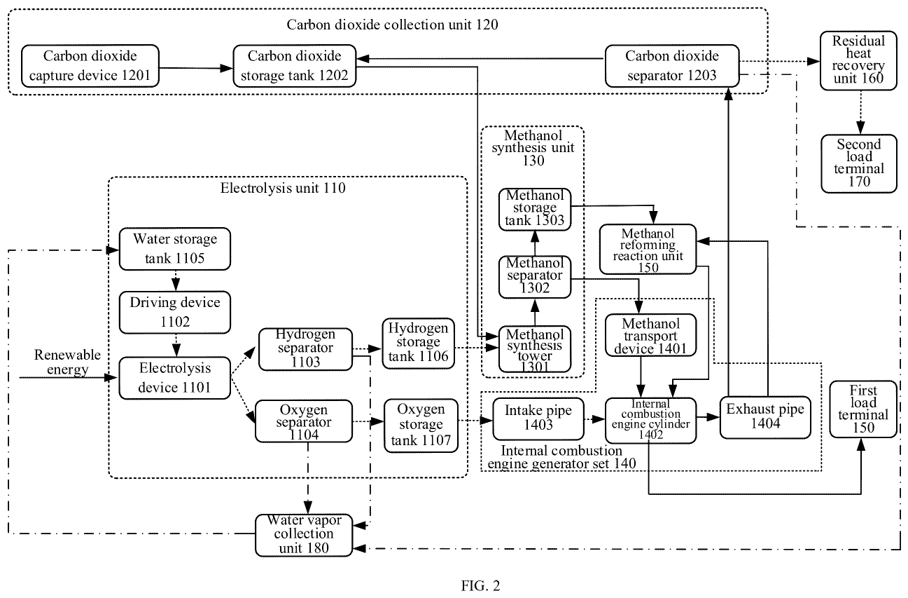

FIG. 2 schematically shows an exemplary architecture diagram of a renewable energy recycling utilization system according to some other embodiments of the present disclosure.

As shown in FIG. 2, the electrolysis unit 110 may include an electrolysis device 1101, a driving device 1102, a hydrogen separator 1103, and an oxygen separator 1104. The electrolysis unit 110 may further include a water storage tank 1105, a hydrogen storage tank 1106, and an oxygen storage tank 1107. The carbon dioxide collection unit 120 may include a carbon dioxide capture device 1201, a carbon dioxide storage tank 1202, and a carbon dioxide separator 1203. The methanol synthesis unit 130 may include a methanol synthesis tower 1301 and a methanol separator 1302. The methanol synthesis unit 130 may further include a methanol storage tank 1303. The internal combustion engine generator set 140 may include a methanol transport device 1401, an internal combustion engine cylinder 1402, an intake pipe 1403, and an exhaust pipe 1404.

According to the embodiments of the present disclosure, the above system may further include a residual heat recovery unit 160 and a water vapor collection unit 180.

According to the embodiments of the present disclosure, the water storage tank 1105 is connected to the driving device 1102, and the driving device 1102 is connected to the electrolysis device 1101. The water storage tank 1105 is used to store pure water for electrolysis. The driving device 1102 may be a pump. The electrolysis device 1101 may be a proton exchange membrane electrolytic bath.

According to the embodiments of the present disclosure, the electrolysis device 1101 is connected to the hydrogen separator 1103 and the oxygen separator 1104. The electrolysis device 1101 uses unstable renewable energy to electrolyze water. The hydrogen mixed gas generated by a cathode is input into the hydrogen separator 1103, and the oxygen mixed gas generated by an anode is input into the oxygen separator 1104.

According to the embodiments of the present disclosure, impurity gas in the hydrogen mixed gas and the oxygen mixed gas is mainly water vapor. The hydrogen separator 1103 separates and dehumidifies the water vapor in the hydrogen mixed gas to obtain hydrogen and separated water vapor. The hydrogen is input into the hydrogen storage tank 1106, and the separated water vapor is input into the water vapor collection unit 180. The water vapor is processed by the water vapor collection unit 180 and is then input into the water storage tank 1105, so as to achieve water circulation.

According to the embodiments of the present disclosure, the oxygen separator 1104 separates and dehumidifies the water vapor in the oxygen mixed gas to obtain oxygen and separated water vapor. The oxygen is input into the oxygen storage tank 1104, and the separated water vapor is input into the water vapor collection unit 180. The water vapor is processed by the water vapor collection unit 180 and is then input into the water storage tank 1105, so as to achieve water circulation.

According to the embodiments of the present disclosure, the hydrogen storage tank 1106 and the carbon dioxide storage tank 1202 are connected to the methanol synthesis tower 1301, for transporting hydrogen and carbon dioxide gas to the methanol synthesis tower respectively. The methanol synthesis tower 1301 synthesizes the methanol mixed gas by using the hydrogen and the carbon dioxide gas. The methanol mixed gas is separated by the methanol separator 1302 to obtain methanol, which may be stored in the methanol storage tank 1303. The methanol separated by the methanol separator 1302 may also be connected to the methanol transport device 1401 to be used as the fuel for the internal combustion engine generator set 140. The methanol storage tank 1303 may also be connected to the methanol reforming reaction unit 150 to perform the reforming reaction of methanol, so as to obtain synthesis gas. The synthesis gas may include hydrogen and carbon monoxide.

According to the embodiments of the present disclosure, in the internal combustion engine generator set 140, methanol is transported to the internal combustion engine cylinder 1402 by the methanol transport device 1401. Oxygen in the oxygen storage tank 1107 is transported to the internal combustion engine cylinder 1402 through the intake pipe 1403, so as to achieve nitrogen-free combustion of methanol in the internal combustion engine cylinder 1402. The exhaust gas generated by combustion may include water vapor and carbon dioxide gas. The mixed gas of water vapor and carbon dioxide gas in the exhaust gas may be separated into water vapor and carbon dioxide gas through the carbon dioxide separator 1203. The carbon dioxide gas is stored in the carbon dioxide storage tank 1202. The water vapor may be recovered by the water vapor collection unit 180.

According to the embodiments of the present disclosure, a first valve is provided between the carbon dioxide storage tank 1202 and the carbon dioxide separator 1203, and the first valve may be a three-phase valve.

According to the embodiments of the present disclosure, the residual heat of the exhaust gas may be used to catalyze the methanol in the methanol reforming reaction unit 150 to obtain synthesis gas. The synthesis gas is input into the internal combustion engine cylinder 1402 and is combusted with methanol to obtain water vapor and carbon dioxide gas.

According to the embodiments of the present disclosure, the electric energy, which is generated by the nitrogen-free combustion of methanol and synthesis gas in the internal combustion engine generator set 140, is supplied for the first load terminal 150.

According to the embodiments of the present disclosure, after the residual heat of the exhaust gas is used by the methanol reforming reaction unit 150, the residual heat of the exhaust gas may be recovered by the residual heat recovery unit 160 for gradient use for a second load terminal 170.

It should be noted that in FIG. 2, the dot dash line arrows represent a water circulation process in the system, and the solid line arrows represent a carbon circulation process in the system. When the first load terminal 150 uses the electric energy, the carbon dioxide gas released into the air may also be recycled by the carbon dioxide capture device 1201, so as to achieve zero discharge of carbon dioxide in the entire system.

According to the embodiments of the present disclosure, in this system, due to nitrogen-free combustion of methanol, the combustion products are only water vapor and carbon dioxide. The residual heat of the exhaust gas from the internal combustion engine generator set is used to catalyze and reform methanol. After the use of the residual heat of the exhaust gas is completed, water vapor and carbon dioxide are easier to be separated without the requirement for increasing new energy consumption. In addition, the separated carbon dioxide and water vapor may be recycled in the system, thereby achieving zero discharge of carbon dioxide and zero discharge of nitrogen oxide for the entire system and achieving high-efficient utilization of energy.

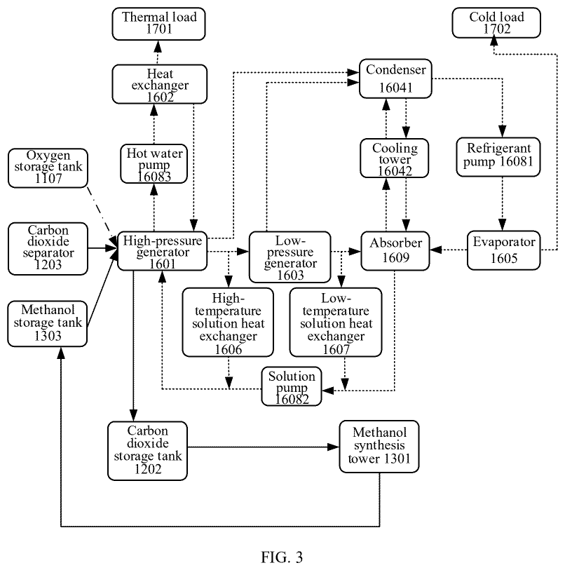

FIG. 3 schematically shows an exemplary architecture diagram of a residual heat recovery unit according to the embodiments of the present disclosure.

As shown in FIG. 3, the residual heat recovery unit 160 in this embodiment may be a residual heat supplemental combustion type cooling and heating set. The residual heat recovery unit 160 may include a high-pressure generator 1601, a heat exchanger 1602, a low-pressure generator 1603, a condenser 16041, a cooling tower 16042, an evaporator 1605, a high-temperature solution heat exchanger 1606, a low-temperature solution heat exchanger 1607, a refrigerant pump 16081, a solution pump 16082, a hot water pump 16083 and an absorber 1609.

According to the embodiments of the present disclosure, the residual heat recovery unit 160 may adopt a dual-effect design. First, the high-pressure generator 1601 absorbs the high-temperature residual heat of the remaining exhaust gas from the carbon dioxide separator 1203. When the residual heat is insufficient, the oxygen storage tank 1107 and the methanol storage tank 1303 provide the fuel for the high-pressure generator 1601 for complementary combustion.

According to the embodiments of the present disclosure, the complementary combustion process is performed in a nitrogen-free combustion manner, and the combustion products are water vapor and carbon dioxide gas. The methanol is synthesized in a carbon circulation process (from the residual heat recovery unit 160 to the methanol synthesis tower 1301 via the carbon dioxide storage tank 1202), and the methanol again participates in the complementary combustion process in the residual heat recovery unit 160, so as to achieve zero carbon discharge.

According to the embodiments of the present disclosure, in a heating process, the high-pressure generator 1601 provides a circulating working medium for the heat exchanger 1602, the hot water pump 16083 provides kinetic energy for the hot water, and the hot water heat exchanger 1602 meets the load requirements of a thermal load 1701.

According to the embodiments of the present disclosure, in a cooling process, the working medium absorbs heat from the high-pressure generator 1602, and the solution pump 16082 provides kinetic energy to the solution to transport the solution to the low-pressure generator 1603. During this process, an intermediate pipeline provides preheating for the solution at an inlet of the high-pressure generator 1601 through the high-temperature solution heat exchanger 1606. The low-pressure generator 1603 transports the solution to the absorber 1609. During this process, an intermediate pipeline provides preheating for the solution at an inlet of the high-temperature solution heat exchanger 1606 through the low-temperature solution heat exchanger 1607. The solution enters the absorber 1609 and is cooled by cooling water provided by the cooling tower 16042. The steam refrigerant in the high-pressure generator 1601 and the low-pressure generator 1603 enters the condenser 16041 and is condensed by the cooling water provided by the cooling tower 16042. The refrigerant is provided with kinetic energy by the refrigerant pump 16081, evaporates and absorbs heat in the evaporator 1605 to provide a cooling load for a cold load 1702. After the refrigerant is evaporated, the refrigerant is absorbed by the low-temperature concentrated solution in the absorber 1609 and transported to the high-pressure generator 1601 for refrigeration cycle again.

It should be noted that in FIG. 3, the dot dash line arrows represent oxygen input, the dashed line arrows represent a circulation of the working medium, and the solid line arrows represent a carbon cycle.

The energy utilization situation of the renewable energy recycling utilization system provided by the embodiments of the present disclosure is further described below in conjunction with FIG. 2 and FIG. 3.

According to the embodiments of the present disclosure, the renewable energy may be derived from wind energy and/or solar energy. The wind turbine and the solar panel may convert the wind energy and the solar energy into electrical energy, which is supplied to the first load terminal 150 through the power grid. For the renewable energy in the embodiments of the present disclosure, the remaining renewable energy may be recycled in the case of electric energy surplus on the power grid, or the renewable energy that is unstable and may not meet the requirements of the power grid may be recycled.

According to the embodiments of the present disclosure, the wind turbine outputs AC power, and the solar panel outputs DC power, which may be shunted after passing through a converter transformer. For the electric energy that may be stably integrated into the power grid, the electric energy may be sent to the power grid to meet the first load terminal 150. An electrochemical energy storage battery may be added to the system as an auxiliary energy storage device for backup power storage. For the electric energy that may not be integrated into the power grid, the converter transformer provides DC power to the electrolysis device 1101, meeting the load requirements for electrolysis of water to produce hydrogen and oxygen. At the same time, the converter transformer may provide electrical and thermal loads for the reaction process in the methanol synthesis tower 1301. Secondly, as a system peak-shaving and power backup, the electrochemical energy storage battery may regulate the current and voltage of the converter transformer, maintaining the power stabilities of the electrolysis device 1101 and the methanol synthesis tower 1301.

According to the embodiments of the present disclosure, the wind turbine and the solar panel may input electrical energy for the entire system, which are the sources of primary energy for the energy system. The electrochemical energy storage battery acts as an auxiliary backup for electrochemical power storage. The electric power that may be integrated into the power grid may be transported to the first load terminal 150 through the power grid. The remaining electric power is supplied using DC power supply. The hydrogen generated by the electrolysis device 1101 and the carbon dioxide in the carbon dioxide storage tank 1202 may synthesize methanol through the methanol synthesis tower 1301. The methanol is stored in the methanol storage tank 1303. When the system needs to peak-shaving and frequency modulated power supply or during periods of insufficient wind power and solar power, the internal combustion engine generator set 140 is coupled with the residual heat recovery unit 160 to meet the requirements of the first load terminal 150, the thermal load 1701 and the cold load 1702. A plurality of internal combustion engine generator sets 140 may be connected in parallel to provide flexible adjustment means for the requirements of electrical energy for the system. The internal combustion engine generator set 140 achieves nitrogen-free combustion, that is, oxygen generated by electrolyzing water, methanol, and synthesis gas generated by reforming methanol are introduced into the internal combustion engine, and some carbon dioxide gas is introduced from the carbon dioxide storage tank 1202. The integrated energy system effectively improves the consumption capacity of wind power and solar photovoltaic power, and achieves zero carbon discharge and zero nitrogen oxide discharge during operation of the system. The system outputs green electricity, cold energy and thermal energy to the outside, achieving zero carbon discharge.

The specific embodiments described above provide further detailed explanations of the purpose, technical solution, and beneficial effects of the present disclosure. It should be understood that the above are only specific embodiments of the present disclosure and are not intended to limit the present disclosure. Any modifications, equivalent substitutions, improvements, etc. made within the spirit and principles of the present disclosure should be included within the scope of protection of the present disclosure.

What is claimed is:

1. A renewable energy utilization system based on nitrogen-free combustion and carbon dioxide recycling, comprising:
an electrolysis unit configured to electrolyze water using renewable energy to obtain hydrogen and oxygen;
a carbon dioxide collection unit configured to collect carbon dioxide gas released during a utilization process of the renewable energy;
a methanol synthesis unit connected to the electrolysis unit and the carbon dioxide collection unit, wherein the methanol synthesis unit is configured to synthesize methanol using the hydrogen and the carbon dioxide gas;
an internal combustion engine generator set connected to the methanol synthesis unit, the electrolysis unit and the carbon dioxide collection unit, wherein the internal combustion engine generator set is configured to combust the methanol with the oxygen, provide electrical energy to a first load terminal, and discharge exhaust gas; and
a methanol reforming reaction unit connected to the internal combustion engine generator set and the methanol synthesis unit, wherein the methanol reforming reaction unit is configured to catalyze a reforming reaction of the methanol using residual heat of the exhaust gas to obtain synthesis gas, and input the synthesis gas into the internal combustion engine generator set as a fuel for the internal combustion engine generator set.

2. The system of claim 1, wherein the methanol synthesis unit comprises:
a methanol synthesis tower configured to react the hydrogen with the carbon dioxide gas to obtain methanol mixed gas; and
a methanol separator connected to the methanol synthesis tower, wherein the methanol separator is configured to separate the methanol mixed gas to obtain the methanol.

3. The system of claim 1, wherein the electrolysis unit comprises:
an electrolysis device connected to a power supply system, wherein the electrolysis device is configured to electrolyze the water to obtain hydrogen mixed gas and oxygen mixed gas;
a driving device connected to the electrolysis device and a water storage tank, wherein the driving device is configured to transport the water to the electrolysis device;
a hydrogen separator connected to the electrolysis device, wherein the hydrogen separator is configured to dehumidify the hydrogen mixed gas to obtain the hydrogen; and
an oxygen separator connected to the electrolysis device, wherein the oxygen separator is configured to dehumidify the oxygen mixed gas to obtain the oxygen.

4. The system of claim 3, wherein the electrolysis device comprises a proton exchange membrane.

5. The system of claim 1, wherein the internal combustion engine generator set comprises:
an internal combustion engine cylinder configured to perform nitrogen-free combustion of the methanol and the oxygen;
a methanol transport device, wherein a first end of the methanol transport device is connected to the methanol synthesis unit, a second end of the methanol transport device is connected to the internal combustion engine cylinder, and the methanol transport device is configured to transport the methanol to the internal combustion engine cylinder;
an intake pipe, wherein a first end of the intake pipe is connected to the electrolysis unit, a second end of the intake pipe is connected to the internal combustion engine cylinder, the intake pipe is configured to transport the oxygen to the internal combustion engine cylinder, a third end of the intake pipe is connected to the methanol reforming reaction unit, and the intake pipe is further configured to transport the synthesis gas to the internal combustion engine cylinder; and
an exhaust pipe, wherein a first end of the exhaust pipe is connected to the internal combustion engine cylinder, a second end of the exhaust pipe is connected to the methanol reforming reaction unit, and the exhaust pipe is configured to transport the exhaust gas to the methanol reforming reaction unit.

6. The system of claim 1, wherein the carbon dioxide collection unit comprises:
a carbon dioxide separator, wherein a first end of the carbon dioxide separator is connected to the internal combustion engine generator set, and the carbon dioxide separator is configured to separate the carbon dioxide gas in the exhaust gas;
a carbon dioxide capture device connected to a carbon dioxide storage tank, wherein the carbon dioxide capture device is configured to collect the carbon dioxide gas released in air during the utilization process of the renewable energy; and
the carbon dioxide storage tank connected to the carbon dioxide separator and the carbon dioxide capture device, wherein the carbon dioxide storage tank is configured to store the carbon dioxide gas in the exhaust gas and the carbon dioxide gas in the air.

7. The system of claim 6, wherein a first valve is provided between the carbon dioxide storage tank and the carbon dioxide separator.

8. The system of claim 1, further comprising:
a residual heat recovery unit connected to the internal combustion engine generator set, wherein the residual heat recovery unit is configured to recover the residual heat of the exhaust gas to provide energy to a second load terminal.

9. The system of claim 8, wherein the residual heat recovery unit is further connected to the carbon dioxide collection unit, and the residual heat recovery unit is further configured to collect the carbon dioxide gas in the exhaust gas after the residual heat of the exhaust gas is recovered; and
wherein the residual heat recovery unit is further connected to the methanol synthesis unit and the electrolysis unit, and the residual heat recovery unit is further configured to perform nitrogen-free combustion using the methanol and the oxygen in a case that the residual heat does not meet an energy requirement of the load terminal, so as to meet the energy requirement of the load terminal.

10. The system of claim 8, further comprising:
a water vapor collection unit connected to the methanol synthesis unit, the carbon dioxide collection unit and the residual heat recovery unit, wherein the water vapor collection unit is configured to collect water vapor generated during a utilization process of methanol fuel.
